(19) United States
(12) Patent Application Publication
(10) Pub. No.: US 2025/0074163 A1
(43) Pub. Date: Mar. 6, 2025

(54) Kinematic Module for an Air Diffuser and Air Diffusers with such a Kinematic Module

(71) Applicant: Illinois Tool Works Inc., Glenview, IL (US)

(72) Inventors: Joachim PESTKE, Enkenbach-Alsenborn (DE); Günther KRÄMER, Enkenbach-Alsenborn (DE)

(21) Appl. No.: 18/822,720

(22) Filed: Sep. 3, 2024

(30) Foreign Application Priority Data
Sep. 4, 2023 (DE) 10 2023 123 759.4

(51) Int. Cl. B60H 1/34; B60H 1/00

(52) U.S. Cl. CPC B60H 1/3421; B60H 1/0065; B60H 2001/3478

(57) ABSTRACT

The disclosure relates to a kinematics module (1) for an air diffuser of a vehicle. The kinematics module (1) can be accommodated as a modular component at least partly or in certain regions in an air diffuser housing, preferably to be possible to be replaced, in order to form the air diffuser.

### RELATED APPLICATION

The present application claims the benefit of German Patent Application No. 10 2023 123 759.4, filed Sep. 4, 2023, titled “Kinematics module for an Air Diffuser and Air Diffusers with such a Kinematics module,” the contents of which are hereby incorporated by reference.

### BACKGROUND

Air diffusers are commonly used in vehicle ventilation systems to control the direction and flow of air into the interior. They are particularly used to supply fresh air to the vehicle's cabin.

Air enters the diffuser through an inlet, passes through an air duct partially enclosed by the diffuser's housing, and exits through an outlet into the vehicle's interior. Typically, the airflow rate (i.e., the amount of air entering the cabin per unit of time) can be manually adjusted using an actuator. Additionally, air diffusers often feature air-guiding elements that direct or regulate the airflow in horizontal or vertical directions, which can also be manually adjusted.

Most air diffusers include closing mechanisms that allow them to be manually switched between an open state (where air flows out) and a closed state (where air is blocked). It's also common for the temperature of air diffusers to be adjustable, either individually or collectively, to provide cooled or heated air to the vehicle's interior.

Air diffusers known from the state of the art are generally designed in such a way that they are equipped for a special purpose, for example for a special type of vehicle or for a special arrangement in the interior of the vehicle. ES air diffusers within a vehicle, for example along a vehicle dashboard, can also have different designs, wherein the air diffusers can differ in terms of the shape and design of the housing, the number of air guiding elements and the design of closing devices and panels arranged on the front or both sides.

It has therefore been customary to design a separate air diffuser for each individual vehicle type and also for each position. This results in relatively high production costs, since the air diffusers can often only be produced in small quantities and a separate air diffuser has to be designed and produced for each application. The resulting additional effort incurs considerable expense and is relatively time-consuming. It is furthermore necessary to check the diffuser performance of every air diffuser.

### SUMMARY

The present disclosure generally relates to air diffuser systems, substantially as illustrated by and described in connection with at least one of the figures, as set forth more completely in the claims. In some examples, the present disclosure relates generally to air diffuser systems for supplying air into the interior of a vehicle, and in particular to corresponding air diffusers.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates schematic and isometric view of an exemplary aspect of the kinematics module according to the disclosure, which is designed here to form a two-duct air diffuser.

FIG. 2 illustrates schematic and in an exploded view of the exemplary aspect of the kinematics module according to the disclosure as shown in FIG. 1.

FIG. 3 illustrates schematic and in an exploded view of the modular kinematic assembly of the exemplary aspect of the kinematics module according to the disclosure as shown in FIG. 1.

### DETAILED DESCRIPTION

Various specific implementations of the present disclosure are described below with reference to the drawings which constitute part of this specification. It should be understood that although the terms indicating directions, such as “front”, “rear”, “upper”, “lower”, “left”, “right” and so on are used in the present disclosure to describe structural parts and elements in various examples of the present disclosure, these terms are used herein only for ease of description and are determined based on the exemplary orientations as shown in the accompanying drawings. Since the arrangements in the embodiments disclosed in the present disclosure may be in various directions, these terms indicating directions are only illustrative and should not be considered as limitations.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The present disclosure is therefore based on the task of specifying a concept with which universal applicability of the air diffuser is ensured. Accordingly, the disclosure relates in particular to a kinematics module for an air diffuser of a vehicle, wherein the kinematics module can be accommodated as a modular component at least partly or in certain regions in an air diffuser housing to form the air diffuser. In particular, it is envisaged in this context that the kinematics module preferably has all the functional components required to manipulate an airflow passing through the air diffuser.

In this context, the kinematics module preferably has all airflow-directing and/or airflow-regulating air guiding elements of the air diffuser. These air guiding elements can preferably be manipulated accordingly in order to effect a targeted deflection and/or directing of an airflow emitted or to be emitted by the air diffuser, in particular in a horizontal and/or vertical direction. Alternatively, or additionally, the kinematics module preferably has all airflow rate regulating elements which can be manipulated at least partly in order to effect a targeted influence on an airflow rate through at least one air duct and/or air sub-duct of the air diffuser.

According to further aspects of the last-mentioned design variants, it is provided that the kinematics module has the kinematic components necessary for manipulating the airflow-directing and/or airflow-regulating air guiding elements as required. Nevertheless, it is conceivable in this context that the kinematics module also has the elements that regulate the airflow rate as required.

According to preferred implementations of the kinematics module according to the disclosure, in particular the last-mentioned aspects, it is provided that the kinematics module preferably has all the components of the kinematic components that influence or define the haptics for manipulating the airflow-directing and/or airflow-regulating air guiding elements as required. In this context, it is also conceivable that the kinematics module preferably has all the components of the kinematic components that influence or define the haptics for manipulating the airflow-regulating elements as required.

An air diffuser constructed according to the teachings of the present disclosure, i.e. an air diffuser with the kinematics module according to the disclosure, is characterized by its modular structure. The modular structure of the air diffuser or kinematics module according to the disclosure makes it possible to make adjustments, optimizations and also cost reductions in individual modules of the air diffuser without the typical “ripple effect” of changes within the entire air diffuser system. The modularization of the air diffuser according to the disclosure reduces product complexity and makes the customer order process more efficient by allowing the air diffuser to be configured specifically to the order instead of being designed specifically to the order.

In other words, the kinematics module according to the disclosure is constructed according to a modular or building block principle, wherein the functional components of the air diffuser are divided into modules or assemblies. The individual modules or assemblies of the modular air diffuser can be joined together or integrated via appropriate interfaces if the form and function are suitable.

The kinematics module (according to the disclosure), which is based on the modular principle and is characterized by its modular structure, makes it possible to create individually configurable air diffusers or air diffuser systems without having to forego economies of scale across all series. The individual modules of the kinematics module or the air diffuser are standardized components that can be flexibly implemented via the modular system using individual adaptation elements.

The advantage of such a modular air diffuser or kinematics module based on the modular principle is, on the one hand, increased flexibility in product and organizational development. Faster product cycles and greater adaptability can be realized if various compatible modules of the air diffuser system are available, which can be attached, removed, exchanged or grouped differently in order to ultimately adapt the air diffuser to new conditions.

The modular structure of the kinematics module according to the disclosure provides the further advantage that a large product variety of air diffusers can be realized in a simple manner. Apart from this, more cost-effective production is possible thanks to identical series and simpler assembly processes.

Finally, the modular design of the kinematics module according to the disclosure also offers advantages with regard to the maintenance of the air diffuser, as a cost-effective repair is possible by replacing the faulty components of the air diffuser. In particular, the air diffuser according to the disclosure has a kinematics module assembly designed as a module, which consists of several sub-assemblies connected or connectable to one another via snap or clip connections.

According to specific aspects of the kinematics module according to the disclosure, this has a supporting structure which in particular has a modular design. The kinematics module also has at least one first set of slats, which is mounted by the supporting structure in such a way that the slats of the first set of slats can be pivoted relative to the supporting structure. Furthermore, according to this realization, the kinematics module comprises at least one second slat extending perpendicularly to the slats of the first set of slats, which is preferably detachably connected to the supporting structure and can be pivoted relative to the supporting structure.

In this context, it is preferable that the kinematics module also has at least one preferably modular kinematic assembly, which is preferably detachably connected to the supporting structure and is configured to transmit an adjustment movement exerted by a user of the air diffuser on an operating element of the air diffuser to the slats of the at least one set of slats and/or to the at least one second slat.

In this context, it is conceivable that the supporting structure has at least one cross strut running perpendicular to the slats of the first set of slats, which is configured to divide an air duct flowing through the supporting structure into sub-ducts.

It is also conceivable that integral or replaceable bearing structures are added to the supporting structure, which preferably ensure axial and/or radial mounting of the airflow-directing and/or airflow-regulating air guiding elements. Furthermore, sliding guides are also conceivable in this context. In general terms, the kinematics module is configured to be accommodated as a modular unit in different air diffuser housings, preferably to be possible to be replaced.

With regard to the air diffuser according to the disclosure, it is provided that it has a housing (air diffuser housing) and a kinematics module of the aforementioned type according to the disclosure, wherein the kinematics module can be accommodated or is accommodated at least partly or in certain regions in the housing to be possible to be replaced, in order to form the air diffuser.

In brief, the kinematics module 1 according to the disclosure shown in the drawings contains all relevant functional elements as a functional unit for: horizontal and vertical air deflection, shutting off or regulating the airflow, and/or haptics (e.g. soft running, force adjustment, detents, etc.).

The functional unit is assembled with other components, in particular the air diffuser housing and, if applicable, panels, to form the air diffuser. It is possible to install a ready-tuned kinematics module 1 in various air diffusers. It is also possible to continue using the kinematics module 1 with only individualized housings and, if necessary, trim parts, thus creating modular air diffusers for a vehicle.

The kinematics module 1 according to the disclosure is characterized by a scalable functional principle for duplication in other functional and installation situations. It comprises automatable sub-units that can be installed in various air diffusers. In addition, the kinematics module 1 according to the disclosure is characterized by its simple functional principle with a limited number of components. In particular, simple housing solutions are also possible and the air diffuser can be easily assembled.

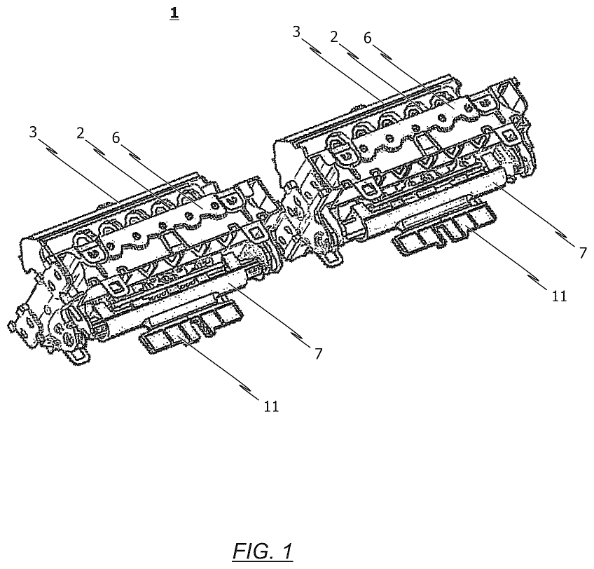

In FIG. 1, an exemplary aspect of the kinematics module 1 according to the disclosure is shown schematically and in an isometric view. The kinematics module 1 as shown in FIG. 1 is used to form a two-duct air diffuser. For this purpose, the kinematics module 1 can be inserted into a corresponding housing of the air diffuser and can be locked there with the housing.

The housing of the air diffuser, which is not shown in FIG. 1, forms an air duct for the airflow passing through the kinematics module 1, which can be manipulated accordingly by the functional components of the kinematics module 1. In particular, the functional components of the kinematics module 1 can be used to deflect the airflow through the kinematics module 1 in a vertical and/or horizontal direction. In addition, the amount of air flowing through the kinematics module 1 and thus through the air diffuser can be adjusted per time unit.

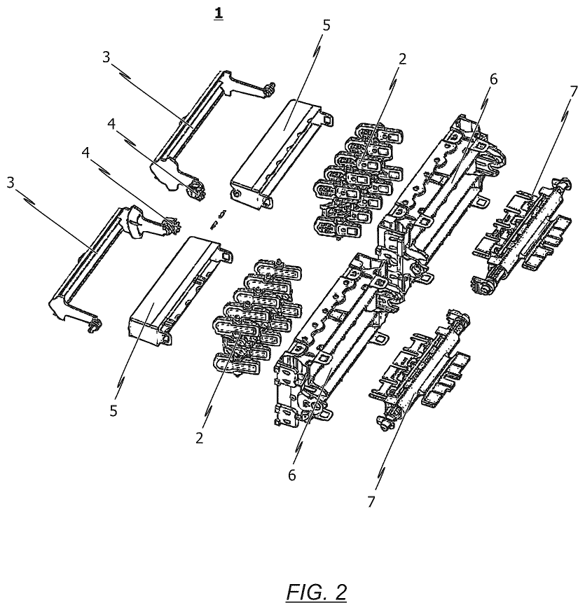

As can be seen in particular from the exploded view according to FIG. 2, the kinematics module 1 of the exemplary aspect has a modular structure and is subdivided into corresponding individual modules, which can be combined and replaced as desired. This is a first functional unit arranged upstream-as seen in the airflow direction-which comprises a shut-off flap 3 mounted to pivot about a vertical axis, via which the airflow rate flowing through the kinematics module 1 per unit of time can be adjusted. The shut-off flap 3 is preferably designed as an injection-molded plastic part and is mounted on an inner housing part 5 to be pivoted.

The inner housing part 5 is detachably connected to a housing frame 6. A first slat assembly 2 is supported by the housing frame 6 in such a way that the individual slats of the first slat assembly 2 can be pivoted relative to the housing frame 6 in order to deflect the airflow in a horizontal direction.

The individual slats of the first slat assembly 2, which are mounted so that to be pivoted by the housing frame 6, can be manipulated accordingly via a kinematic assembly 7 of the kinematics module 1. The kinematic assembly 7 is arranged downstream of the kinematics module 1—viewed in the direction of airflow-and is detachably connected to the housing frame 6.

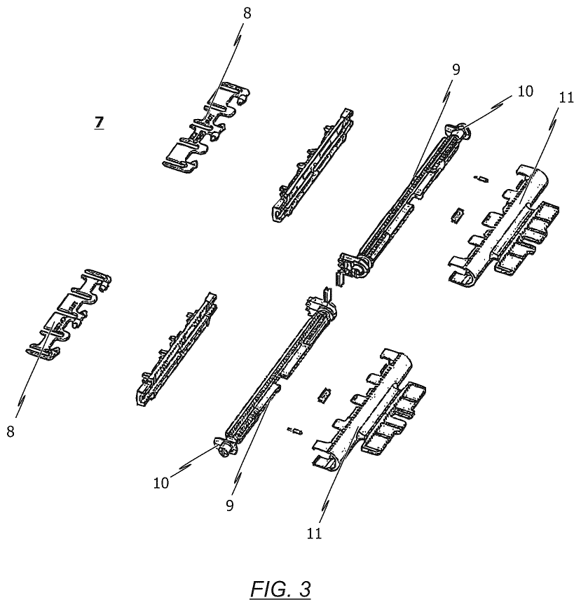

As can be seen in particular from the isometric exploded view in FIG. 3, the kinematic assembly 7 of the kinematics module 1 also has a modular structure and comprises a horizontally extending axis 9, via which the kinematic assembly 7 of the kinematics module 1 is mounted to be pivoted with the housing frame 6. A corresponding gear element 10 is arranged on the axle 9, which interacts with a gear element 4 arranged on the shut-off flaps 3. Pivoting the axle 9 thus manipulates the active connected shut-off flap 3 accordingly.

A sliding element 11 is displaceably arranged on the axis 9, which is connected to a comb structure 8, wherein this comb structure 8 interacts with the individual slats of the first slat assembly 2, so that the slats of the first slat assembly 2 can be manipulated when the sliding element 11 is displaced along the axis 9.

In addition, the sliding element 11, which serves as the handle part, can be pivoted with the axis 9 relative to the housing frame 6 in order to deflect the air in a vertical direction.

Features of the kinematics module 1 according to the disclosure are summarized below.

As a functional unit, kinematics module 1 contains all the relevant functional elements for: horizontal and vertical air deflection; shut-off or regulation of the airflow; and/or haptics (soft running, force adjustment, detents . . . ).

This functional unit is assembled with other components (housing, panels) to form an air diffuser. It is possible to install a fully tuned kinematics module 1 in various air diffusers. It is also possible to continue using the kinematics module 1 across all air diffusers with only individualized housings and trim parts, thus creating modular air diffusers for a vehicle.

The kinematics module 1 represents a scalable functional principle for duplication in other functional and installation situations. The individual modules of kinematics module 1 can be installed as sub-units in various air diffusers. Furthermore, the functional principle is simplified with a limited number of components, so that simple housing solutions and simple assembly of the air diffusers are possible.

Although the present disclosure is described with reference to the examples of embodiments outlined above, various alternatives, modifications, variations, improvements and/or substantial equivalents, which are known or anticipated at present or to be anticipated before long, may be obvious to those of at least ordinary skill in the art. In addition, the technical effects and/or technical problems described in this specification are exemplary rather than limiting; Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

### LIST OF REFERENCE NUMERALS

1 Kinematics module
2 First slat assembly
3 Shut-off flap
4 Gear clement of the shut-off flap
5 Inner housing part
6 Housing frame
7 Kinematic assembly
8 Comb structure
9 Axis
10 Gear clement of the axis
11 Sliding clement

What is claimed is:

1. A kinematics module (1) for an air diffuser of a vehicle, wherein the kinematics module (1) is a modular component configured to reside at least partly in an air diffuser housing in order to form the air diffuser.

2. The kinematics module (1) according to claim 1, wherein the kinematics module (1) comprises functional components configured to manipulate an airflow through the air diffuser or an airflow to be emitted by the air diffuser.

3. The kinematics module (1) according to claim 1, wherein the kinematics module (1) comprises airflow-directing and/or airflow-regulating air guiding elements of the air diffuser, which can be manipulated at least partly accordingly in order to effect a targeted deflection and/or direction of an airflow emitted or to be emitted by the air diffuser, in particular in a horizontal direction and/or a vertical direction.

4. The kinematics module (1) according to claim 1, wherein the kinematics module (1) comprises airflow rate regulating elements configured to effect a targeted influencing of an airflow rate through at least one air duct and/or air sub-duct of the air diffuser.

5. The kinematics module (1) according to claim 3, wherein the kinematics module (1) comprises all kinematic components of the air diffuser necessary for manipulating the airflow-directing and/or airflow-regulating air guiding elements.

6. The kinematics module (1) according to claim 3, wherein the kinematics module (1) comprises the elements regulating airflow rate.

7. The kinematics module (1) according to claim 5, wherein the kinematics module (1) comprises components of the kinematic components that influence or define a haptic for manipulating the airflow-directing and/or airflow-regulating air guiding elements as required.

8. The kinematics module (1) according to claim 5, wherein the kinematics module (1) preferably comprises components of the kinematic components that influence or define haptics for manipulating the airflow-regulating elements as required.

9. The kinematics module (1) according to claim 6,
wherein the kinematics module (1) comprises the following:
a supporting structure, which in particular has a modular design;
at least one first set of slats, which is preferably detachably connected or connectable to the supporting structure and is mounted by the supporting structure in such a way that the slats of the first set of slats can be pivoted relative to the supporting structure; and
at least one second slat extending perpendicular to the slats of the first set of slats, which is preferably detachably connected to the supporting structure and can be pivoted relative to the supporting structure.

10. The kinematics module (1) according to claim 9, wherein the kinematics module (1) further comprises at least one preferably modular kinematic assembly, which is preferably detachably connected to the supporting structure and is configured to transmit an adjustment movement exerted by a user of the air diffuser on an operating element of the air diffuser to the slats of the at least one set of slats and/or to the at least one second slat.

11. The kinematics module (1) according to claim 9, wherein the supporting structure has at least one cross strut extending perpendicular to the slats of the first set of slats, which is configured to divide an air duct flowing through the supporting structure into sub-ducts.

12. The kinematics module (1) according to claim 7, wherein the kinematics module (1) is configured as a modular unit in different air diffuser housings, preferably to be possible to be replaced.

13. An air diffuser for a vehicle, wherein the air diffuser has the following:
a housing; and
a kinematics module (1) according to claim 1,
wherein the kinematics module (1) can be accommodated or is accommodated at least party or in certain regions in the housing to be possible to be replaced, in order to form the air diffuser.
